(19) United States
(12) Patent Application Publication
(10) Pub. No.: US 2009/0237922 A1
(43) Pub. Date: Sep. 24, 2009

(54) LED tube light

(75) Inventor: Chun-Chun Chiu, Kowloon (CN)

Correspondence Address: ALIX YALE & RISTAS LLP, 750 MAIN STREET, SUITE 1400, HARTFORD, CT, 06103, US

(73) Assignee: Gama Sonic Industries (H.K.) Limited, Kowloon (CN)

(21) Appl. No.: 12/077,354

(22) Filed: Mar. 18, 2008

(51) Int. Cl. F21S 4/00

(52) U.S. Cl. 362/223; 362/217.1; 362/225

(57) ABSTRACT

A tubular light includes a light-transmissive tube with an end cap fitted to each end. An electrical contact terminal extends from each end cap, and an array of LEDs is attached to each end cap and receives electrical power via the respective contact terminals. The LEDs are configured to emit light along the tube to impinge upon the tube internally. The tube is preferably translucent so as to glow and radiate light evenly thereabout. The light is sized and shaped to be received by, and functional with a light fitting designed for a fluorescent tube of standard form factor. An alternate configuration an elongate member located within the tube and a multitude of LEDs mounted upon the elongate member to receive electrical power via the electrical contact terminal. The LEDs are configured to emit light at a number of angularly offset radial directions toward an inner surface of the tube.

### BACKGROUND OF THE INVENTION

The invention relates to lighting. The invention more particularly, although not exclusively, relates to tube lighting with encased LEDs.

Fluorescent tubes have been used for many years as an energy-efficient alternative to incandescent lighting. Modern high-intensity LEDs are even more efficient than fluorescent tubes, however existing fluorescent light fittings are designed to receive fluorescent tubes of various standard form factors. Some manufacturers provide an LED replacement light in a standard fluorescent tube form factor for easy retrofitting. Such replacement tubes are known to comprise an elongate planar circuit board extending longitudinally within a plastics tube and comprising an array of LEDs which are soldered onto the circuit board—all facing in the same direction transverse to the longitudinal extent of the tube.

The above known configuration does not result in a desirable widespread dispersion of light as the known light fittings were originally designed for fluorescent tubes which radiate light in all radial directions transverse to the longitudinal extent of the fluorescent tubes.

Another problem associated with known fluorescent tubes is of course associated with breakage and disposal because the tubes contain a phosphor coating and Mercury.

### OBJECTS OF THE INVENTION

It is an object of the present invention to overcome or substantially ameliorate at least one of the above disadvantages and/or more generally to provide an improved LED Tube light.

### DISCLOSURE OF THE INVENTION

There is disclosed herein a tubular light, comprising:
a light-transmissive tube;
an end cap fitted to an end of the tube;
an electrical contact terminal extending from the end cap; and
an LED attached to the end cap and receiving electrical power via the contact terminal and configured to emit light along the tube to impinge upon the tube internally.

Preferably, the tube is cylindrical and has a said end cap fitted to each end thereof in such manner that the LED of each end cap is directed toward the other end cap.

Preferably, each end cap has a pair of said electrical contact terminals.

Preferably, each end cap comprises an array of LEDs, in which each LED of the array is configured to emit light along the tube to impinge upon the tube internally.

Preferably, the light-transmissive tube is substantially clear.

Alternatively, the light-transmissive tube is translucent. Alternatively, the light-transmissive tube is substantially clear with a translucent coating on its inner and/or outer surfaces.

Preferably, the tubular light is sized and shaped to be received by and functional with a light fitting designed for a fluorescent tube of standard form factor.

There is further disclosed herein a tubular light, comprising:
a light-transmissive tube;
an end cap at an end of the tube;
an electrical contact terminal on the end cap;
an elongate member located within the tube;
a multitude of LEDs mounted upon the elongate member to receive electrical power via the electrical contact and wherein the LEDs are configured to emit light at a number of angularly offset substantially radial directions toward an inner surface of the tube.

Preferably, the elongate member is substantially cylindrical having a central longitudinal axis.

Preferably, the LEDs are provided in a number of linear arrays which extend longitudinally of the elongate member and wherein each said array is offset radially with respect to each other array, and wherein each LED is directed radially outwardly of the longitudinal axis.

Preferably, each end cap includes an electrical contact pin associated with the respective electrical contact terminal and the contact pin engages the elongate member to convey electrical power to the LEDs.

Preferably, each end cap has a pair of said electrical contact terminals and a pair of said electrical contact pins.

Preferably, the light-transmissive tube is substantially clear.

Alternatively, the light-transmissive tube is translucent.

As a further alternative, the light-transmissive tube can be substantially clear with a translucent coating on its inner and/or outer surfaces.

Preferably, the light is sized and shaped to be received by and functional with a light fitting designed for a fluorescent tube of standard form factor.

There is further disclosed herein a light fitting, comprising:
a light-transmissive tube curved in a C-shape;
an end cap at an end of the tube;
an electrical contact terminal on the end cap;
a C-shaped internal member located within the tube;
a multitude of LEDs mounted upon the internal member to receive electrical power via the electrical contact and wherein the LEDs are configured to emit light at a number of angularly offset substantially radial directions toward an inner surface of the tube.

Preferably, the internal member has a curved central axis.

Preferably, the LEDs are provided in a number of linear arrays which extend along the internal member and wherein each said array is offset radially with respect to each other array, and wherein each LED is directed radially outwardly of the central axis.

Preferably, each end cap includes an electrical contact pin associated with the respective electrical contact terminal and the contact pin engages the internal member to convey electrical power to the LEDs.

Preferably, each end cap has a pair of said electrical contact terminals and a pair of said electrical contact pins.

Preferably, the light-transmissive tube is substantially clear.

Alternatively, the light-transmissive tube can be translucent.

Alternatively, the light-transmissive tube can be substantially clear with a translucent coating on its inner and/or outer surfaces.

The light fitting can be sized and shaped to be received by and functional with a light fitting designed for a fluorescent tube of standard form factor.

Preferably, the tube comprises mutually interconnected upper and lower C-shaped shells.

### BRIEF DESCRIPTION OF THE DRAWINGS

Preferred forms of the present invention will now be described by way of example with reference to the accompanying drawings, wherein:

FIG. 1 is a schematic perspective illustration of an LED tube light;

FIG. 2 is a schematic side-on illustration of the LED tube light of FIG. 1;

FIG. 3 is a schematic parts-exploded side-on illustration of the LED tube light of FIGS. 1 and 2;

FIG. 4 is a schematic perspective illustration of another LED tube light;

FIG. 5 is a schematic side-on illustration of the LED tube light of FIG. 4;

FIG. 6 is a schematic end elevation of inner parts of the LED tube light of FIGS. 4 and 5; and

FIG. 7 is a schematic parts-exploded side-on illustration of the LED tube light of FIGS. 4 and 5.

FIG. 8 is a schematic plan illustration of yet another LED light fitting;

FIG. 9 is a schematic end elevation of inner parts of the LED light fitting of FIG. 8;

FIG. 10 is a schematic plan illustration of the inner parts of the LED light fitting of FIG. 9;

FIG. 11 is a schematic parts-exploded perspective illustration of the LED light fitting of FIGS. 8 to 10.

### DESCRIPTION OF THE PREFERRED EMBODIMENTS

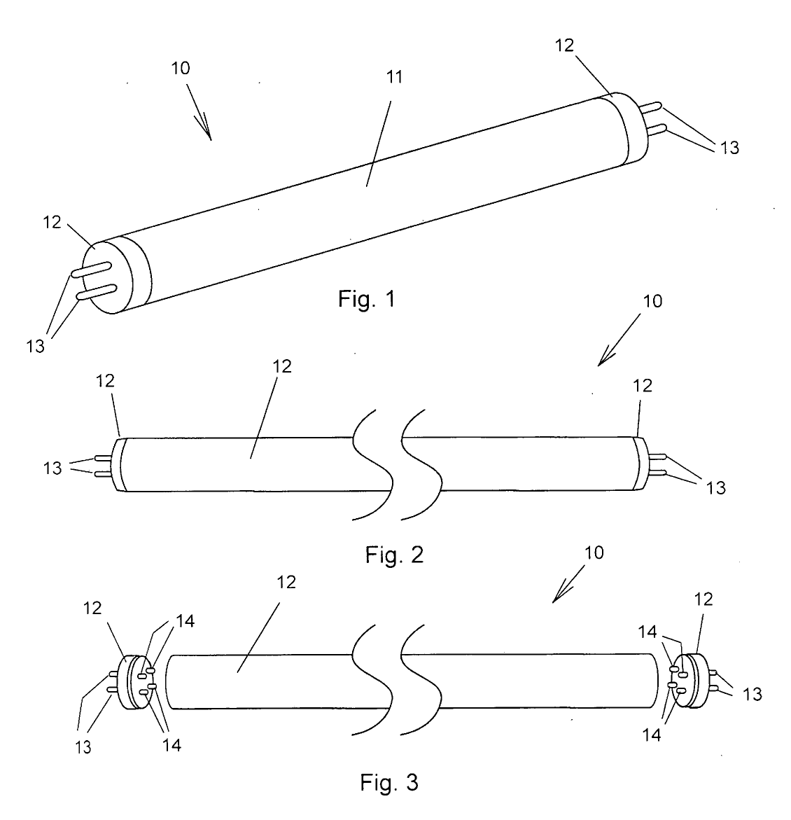

In FIGS. 1 to 3 of the accompanying drawings there is depicted schematically a tube light 10 made in a standard fluorescent tube form factor for fitting into standard light fittings. The tube light 10 comprises a light-transmissive tube 11 with end caps 12 each having electrical contact terminals 13 projecting longitudinally therefrom for contact with corresponding terminals in the light fitting itself.

The tube 11 is typically of plastics material or glass and might be substantially clear or translucent. It might be of substantially clear material with a translucent coating on its inner and/or outer surfaces.

LEDs 14 are mounted to each of the end caps 12 and face in the longitudinal direction of the tube light 10. The LEDs 14 are typically high-intensity devices capable of emitting very bright and narrowly diverging light which impinges upon the inner surface of the plastics tube 11 causing the tube 11 to glow and thereby radiate light in all radial directions.

As the tube light 10 is intended to be installed in standard high-voltage light fittings, a voltage transformer or transformers can be housed within one or both end caps 12 to supply the appropriate low voltage source to the LEDs 14.

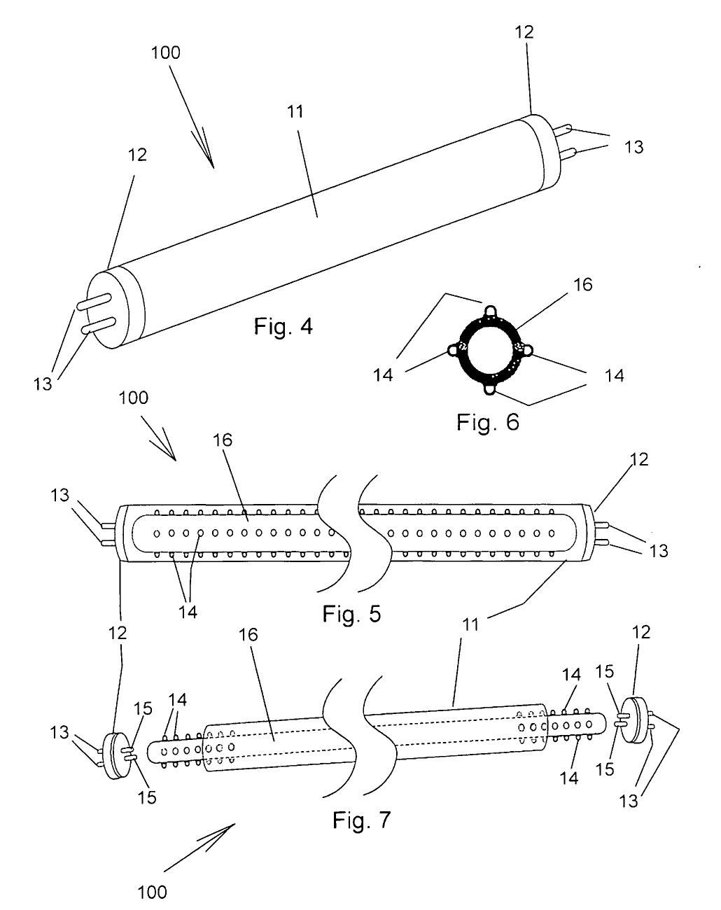

In FIGS. 4 to 7 there is depicted schematically a tube light 100 made in a standard fluorescent tube form factor for fitting into standard light fittings. The tube light 100 comprises a light-transmissive tube 11 with end caps 12 each having external electrical contact terminals 13 projecting longitudinally therefrom for contact with corresponding terminals in the light fitting itself. There are two corresponding internal contact pins 15 at each end cap 12 which project internally of the tube 11.

The tube 11 is typically of plastics material or glass and might be substantially clear or translucent. It might be of substantially clear material with a translucent coating on its inner and/or outer surfaces.

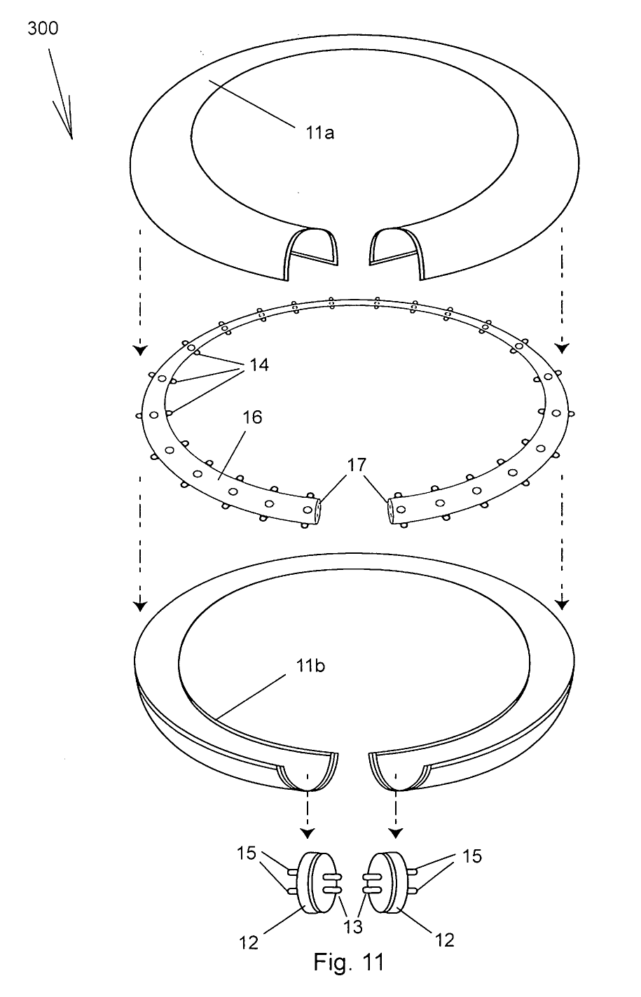

Located within the tube 11 is an elongate member 16 having a pair of electrical sockets 17 (see FIG. 11 for detail) at each end and into which the internal contact pins 15 of each end cap are received.

The elongate member 16 has a multitude of LEDs 14 extending therealong and spaced radially thereabout. In the depicted embodiment, there are four elongate parallel rows of LEDs 14 with each row being spaced evenly about the elongate member 16 as shown in FIG. 6.

Alternatively, there could be two, three, or five or more rows of LEDs. As a further alternative, a single row or multiple rows of LEDs could be spiralled or zigzagged about the elongate member 16. The LEDs are electrically connected internally of the elongate member with the electrical sockets (not shown) at each end thereof.

As the tube light 100 is intended to be installed in standard high-voltage light fittings, a voltage transformer or transformers can be housed within one or both end caps 12 to supply the appropriate low voltage source to the LEDs 14 via the pins 15 which are of course inserted into the sockets at each end of the elongate member 16.

When the LEDs 14 are illuminated, they emit light upon the inside surface of the tube 11. If by choice the tube 11 is substantially clear, the light from each LED passes through the tube 11 substantially unaffected. Where sufficient LEDs are provided, the resultant overall emission of light from the tube light is in substantially all radial directions. If on the other hand the tube 11 is translucent or substantially clear with a translucent inner and/or outer coating, the tube will defuse and thereby soften the light somewhat, but otherwise result in light emission in substantially all radial directions.

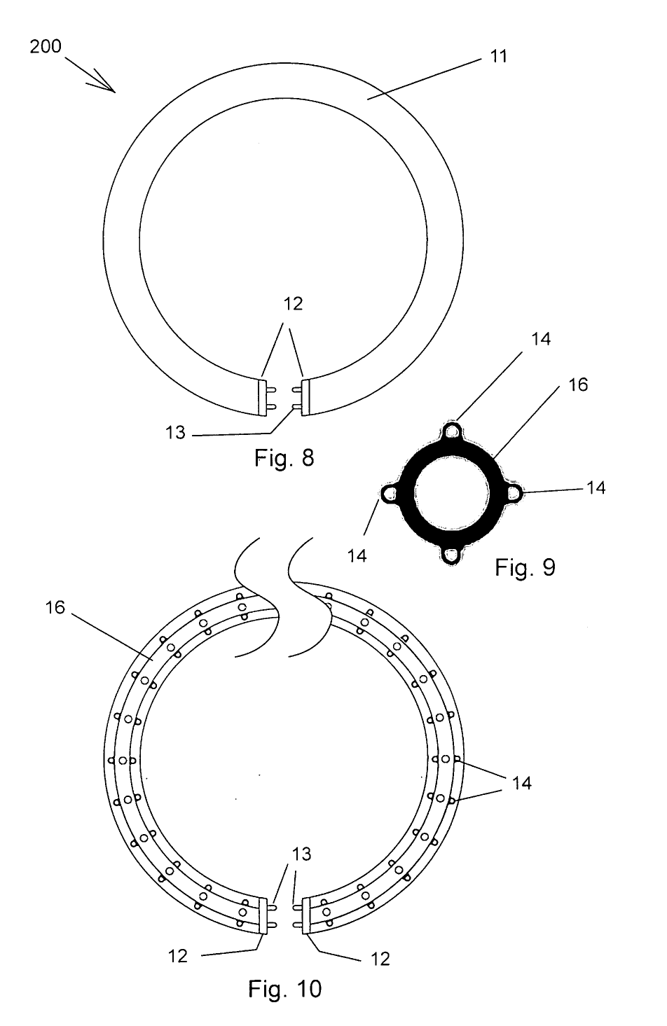

In FIGS. 8 to 11 there is depicted schematically a light fitting 300 made in a standard C-shaped or “doughnut” fluorescent tube form factor for fitting into standard light fittings. The light fitting 300 comprises a light-transmissive C-shaped tube 11a/11b with end caps 12 each having external electrical contact terminals 13 projecting therefrom for contact with corresponding terminals in the light fitting itself. There are two corresponding internal contact pins 15 at each end cap 12 which project internally of the tube.

The tube 11a/11b comprises an upper tube shell 11a and a lower tube shell 11b which are mutually interconnected to form a C-shaped enclosure having a substantially circular cross-section. Each shell is typically of plastics material or glass and might be substantially clear or translucent. It might be of substantially clear material with a translucent coating on its inner and/or outer surfaces.

Located within the tube 11a, 11b is an internal member 16 having a pair of electrical sockets 17 at each end and into which the internal contact pins 15 of each end cap are received.

Apart from the C-shaped nature of the internal member 16, its function and provision of LEDs is for all intents and purposes the same as elongate member 16 which is described above in relation to the embodiment depicted in FIGS. 4 to 7. When the LEDs 14 are illuminated, they emit light upon the inside surface of the tube shells 11a/11b. If by choice the tube shells are substantially clear, the light from each LED passes through the shells 11a, 11b substantially unaffected. Where sufficient LEDs are provided, the resultant overall emission of light from the light fitting is in substantially all radial directions. If on the other hand the tube shells 11a, 11b are translucent or substantially clear with a translucent inner and/or outer coating, the tube will defuse and thereby soften the light somewhat, but otherwise result in light emission in substantially all radial directions. As there are two separate shells, it is of course not essential that they both be provided with the same diffusive features. For example, shell 11a might be clear, translucent or even opaque, whereas shell 11b might be clear, translucent or otherwise as described above.

It should be appreciated that modifications and alterations obvious to those skilled in the art are not to be considered as beyond the scope of the present invention. For example, the inside surface of the tube 11 could be roughened or be otherwise provided with surface imperfections or projections to better receive the light emitted by the LEDs 14. Furthermore, instead of providing a single elongate member 16, a pair of half length elongate members could be provided with each member being attached to only one of the end caps 12.

1. A tubular light, comprising:
a light-transmissive tube;
an end cap fitted to an end of the tube;
an electrical contact terminal extending from the end cap; and
an LED attached to the end cap and receiving electrical power via the contact terminal and configured to emit light along the tube to impinge upon the tube internally.

2. The tubular light of claim 1, wherein the tube is cylindrical and has a said end cap fitted to each end thereof in such manner that the LED of each end cap is directed toward the other end cap.

3. The tubular light of claim 2, wherein each end cap has a pair of said electrical contact terminals.

4. The tubular light of claim 2, wherein each end cap comprises an array of LEDs, in which each LED of the array is configured to emit light along the tube to impinge upon the tube internally.

5. The tubular light of claim 1, wherein the light-transmissive tube is substantially clear.

6. The tubular light of claim 1, wherein the light-transmissive tube is translucent.

7. The tubular light of claim 1, wherein the light-transmissive tube is substantially clear with a translucent coating on its inner and/or outer surfaces.

8. The tubular light of claim 1, being sized and shaped to be received by and functional with a light fitting designed for a fluorescent tube of standard form factor.

9. A tubular light, comprising:
a light-transmissive tube;
an end cap at an end of the tube;
an electrical contact terminal on the end cap;
an elongate member located within the tube;
a multitude of LEDs mounted upon the elongate member to receive electrical power via the electrical contact and wherein the LEDs are configured to emit light at a number of angularly offset substantially radial directions toward an inner surface of the tube.

10. The tubular light of claim 9, wherein the elongate member is substantially cylindrical having a central longitudinal axis.

11. The tubular light of claim 10, wherein the LEDs are provided in a number of linear arrays which extend longitudinally of the elongate member and wherein each said array is offset radially with respect to each other array, and wherein each LED is directed radially outwardly of the longitudinal axis.

12. The tubular light of claim 10, wherein each end cap includes an electrical contact pin associated with the respective electrical contact terminal and the contact pin engages the elongate member to convey electrical power to the LEDs.

13. The tubular light of claim 12, wherein each end cap has a pair of said electrical contact terminals and a pair of said electrical contact pins.

14. The tubular light of claim 9, wherein the light-transmissive tube is substantially clear.

15. The tubular light of claim 9, wherein the light-transmissive tube is translucent.

16. The tubular light of claim 9, wherein the light-transmissive tube is substantially clear with a translucent coating on its inner and/or outer surfaces.

17. The tubular light of claim 9, being sized and shaped to be received by and functional with a light fitting designed for a fluorescent tube of standard form factor.

18. A light fitting, comprising:
a light-transmissive tube curved in a C-shape;
an end cap at an end of the tube;
an electrical contact terminal on the end cap;
a C-shaped internal member located within the tube;
a multitude of LEDs mounted upon the internal member to receive electrical power via the electrical contact and wherein the LEDs are configured to emit light at a number of angularly offset substantially radial directions toward an inner surface of the tube.

19. The light fitting of claim 18, wherein the internal member has a curved central axis.

20. The light fitting of claim 19, wherein the LEDs are provided in a number of linear arrays which extend along the internal member and wherein each said array is offset radially with respect to each other array, and wherein each LED is directed radially outwardly of the central axis.

21. The light fitting of claim 19, wherein each end cap includes an electrical contact pin associated with the respective electrical contact terminal and the contact pin engages the internal member to convey electrical power to the LEDs.

22. The light fitting of claim 21, wherein each end cap has a pair of said electrical contact terminals and a pair of said electrical contact pins.

23. The light fitting of claim 18, wherein the light-transmissive tube is substantially clear.

24. The light fitting of claim 18, wherein the light-transmissive tube is translucent.

25. The light fitting of claim 18, wherein the light-transmissive tube is substantially clear with a translucent coating on its inner and/or outer surfaces.

26. The light fitting of claim 18, being sized and shaped to be received by and functional with a light fitting designed for a fluorescent tube of standard form factor.

27. The light fitting of claim 18, wherein the tube comprises mutually interconnected upper and lower C-shaped shells.
